(19) United States
(12) Patent Application Publication
(10) Pub. No.: US 2002/0181857 A1
(43) Pub. Date: Dec. 5, 2002

(54) Optical wavelength multiplexer/demultiplexer

(75) Inventors: Takuya Komatsu, Tokyo (JP); Kazutaka Nara, Tokyo (JP); Kazuhisa Kashihara, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: The Furukawa Electric Co., Ltd., Tokyo (JP)

(21) Appl. No.: 10/145,108

(22) Filed: May 15, 2002

(30) Foreign Application Priority Data
May 15, 2001 (JP) 2001-145098
Nov. 7, 2001 (JP) 2001-342207

(51) Int. Cl. G02B 6/293; G02B 6/12; G02B 6/30

(52) U.S. Cl. 385/24; 385/14; 385/49

(57) ABSTRACT

An optical wavelength multiplexer/demultiplexer of the present invention is such an optical wavelength multiplexer/demultiplexer capable of approximating, for instance, an optical transmission center wavelength to be multiplexed/demultiplexed to a designed wavelength in an easy manner, while transmission loss and adjacent crosstalk are low. Optical multiplexing/demultiplexing circuits (8(8A, 8B, 8C)) such as Mach-Zehnder optical interferometers having wavelength multiplexing/demultiplexing functions and formed by optical waveguides, are formed on substrates (1(1A, 1B, 1C)) different from each other, so that a plurality of optical waveguide circuit chips (7(7A, 7B, 7C)) are fabricated. These plural optical waveguide circuit chips (7(7A, 7B, 7C)) are connected to each other via an optical fiber (2). A temperature control means (5(5A, 5B, 5C)) is provided in each of the optical waveguide circuit chips (7(7A, 7B, 7C)), and the temperature control means controls a temperature of each of the optical waveguide circuit chips so as to adjust an optical transmission center wavelength of the corresponding optical multiplexing/demultiplexing circuit (8(8A, 8B, 8C)).

### FIELD OF THE INVENTION

The present invention is related to an optical wavelength multiplexer/demultiplexer employed in optical communications and the like.

### BACKGROUND OF THE INVENTION

Very recently, traffics in the Internet are rapidly increased. Under such circumstances, expansion of communication network capacities is strongly required. In connection with these strong demands, wavelength division multiplexing (WDM) transmission techniques have been positively developed and popularized. Since the wavelength division multiplexing transmission techniques correspond to techniques capable of multiplexing a plurality of optical signals having different wavelengths with each other to transmit the multiplexed-optical signal to a single optical fiber, a transmission capacity can be expanded by a total number of multiplexed wavelengths.

Also, currently, a high-density wavelength division multiplexing transmission (Dense-WDM) system is practically available in which wavelength intervals in a wavelength division multiplexing transmission system are narrowed. In this high-density wavelength division multiplexing transmission system, since a wavelength range of 1.55 μm equal to a minimum transmission loss wavelength of a silica-based optical fiber is more effectively used, signal lights are multiplexed and a signal light is demultiplexed in a very narrow wavelength interval, for instance, approximately 0.8 nm.

In order to realize such a wavelength division multiplexing transmission system as the above-described high-density wavelength division multiplexing transmission, optical wavelength multiplexers/demultiplexers equipped with optical multiplexing/demultiplexing circuits are required, while this optical multiplexing/demultiplexing circuits own wavelength multiplexing/demultiplexing functions. This wavelength multiplexing/demultiplexing function corresponds to such a function that lights having a plurality of wavelengths may be multiplexed with each other, light having plural wavelengths may be demultiplexed to obtain lights having a plurality of wavelengths, and both the multiplexing operation and the demultiplexing operation may be carried out.

For instance, in such a wavelength division multiplexing transmission system, an optical wavelength multiplexer/demultiplexer provided for executing the multiplexing operation multiplexes lights having plural wavelengths with each other. The wavelength-multiplexed light which is formed by the multiplexing operation is transmitted to an optical fiber. Also, for instance, such an optical wavelength multiplexer/demultiplexer provided for the demultiplexing operation demultiplexes the wavelength-multiplexed light transmitted via the optical fiber. The demultiplexed lights are derived corresponding to each wavelength.

As one example of such an optical wavelength multiplexer/demultiplexer, an optical waveguide type optical wavelength multiplexer/demultiplexer may be employed. This optical waveguide type optical wavelength multiplexer/demultiplexer is manufactured in such a manner that an optical multiplexing/demultiplexing circuit formed by an optical waveguide is formed on a substrate. The above-described optical multiplexing/demultiplexing circuit owns a wavelength multiplexing/demultiplexing circuit owns a wavelength multiplexing/demultiplexing function. Since high-precision pattern techniques which have been developed in semiconductor fields may be applied to such an optical waveguide type optical wavelength multiplexer/demultiplexer, superior designing characteristics thereof may be obtained.

An example of the above-described optical multiplexing/demultiplexing circuit is shown in FIG. 16A and FIG. 16B. The optical multiplexing/demultiplexing circuit 8 shown in FIG. 16A and FIG. 16B corresponds to a circuit of an arrayed waveguide grating.

The circuit arrangement of this arrayed waveguide grating contains at least one optical input waveguide 22, a first slab waveguides 23 connected to an output end of the optical input waveguides 22, an arrayed waveguide 24 connected to an output end of the first slab waveguide 23, a second slab waveguide 25 connected to an output end of the arrayed waveguide 24 and, a plurality of optical output waveguides 26 arranged side by side and connected to an output end of the second slab waveguide 25.

The arrayed waveguide 24 transmits light derived from the first slab waveguide 23, and is included a plurality of channel waveguides 24a. While lengths of adjacent channel waveguides 24a are set by different setting amounts (ΔL) from each other, the arrayed waveguide 24 constitutes a phase portion of the arrayed waveguide grating.

It should be understood that there are normally provided a large number of channel waveguide 24a which constitute the arrayed waveguide 24, for instance, 100 pieces of channel waveguides 24a are employed. Also, a plurality of optical output waveguides 26 are employed, the total number of which corresponds to such a total number of signal lights having different wavelengths, which is multiplexed, or demultiplexed by, for example, the arrayed waveguide grating. It should also be noted that for the sake of simple illustrations in FIG. 16A and FIG. 16B, plural sets of these channel waveguides 24a, optical output waveguides 26, and optical input waveguides 22 are briefly illustrated.

For example, as indicated in FIG. 16A, in the circuit of such an arrayed waveguide grating, wavelength-multiplexed light is conducted to one of the optical input waveguides 22. As a result, this wavelength-multiplexed light is conducted via one of the optical input waveguide 22 to the first slab waveguide 23, and then, is widened due to the diffraction effect thereof. The widened wavelength-multiplexed light is entered into the arrayed waveguide 24 and then, is propagated through this arrayed waveguide 24.

The light which has been propagated through this arrayed waveguide 24 is reached to the second slab waveguide 25, and is further condensed to the optical output waveguide 26 so as to be outputted. In this case, since the lengths of all of these channel waveguides 24a employed in the arrayed waveguide 24 are different from each other, phases of the respective light are shifted after the light has been penetrated through the arrayed waveguide 24. In response to this phase shift amount, the phase front of the condensed light is tilted. Based upon this tilt angle, the position where the lights are condensed may be determined.

As a result, since the light condensing positions as to the lights having the different wavelengths are different from each other, the optical output waveguides 26 are formed at these light condensing positions, so that such lights having the different wavelengths can be outputted from the different optical output waveguides 26 corresponding to each wavelength.

Since the arrayed waveguide grating owns the above-described characteristic, the arrayed waveguide grating may be employed as an optical transmission device operable for optical demultiplexing operation, while this optical transmission device may be applied to the wavelength-multiplexing transmission system.

Also, the arrayed waveguide grating utilizes the principle idea of reversibility of optical circuits, this arrayed waveguide grating may have both the optical demultiplexing function and the optical multiplexing function. In other words, when a plurality of light having different wavelengths from each other are entered from the respective optical output waveguides 26, the plural lights are propagated through transmission paths opposite to the above-explained transmission paths, and then, are multiplexed with each other by the second slab waveguide 25, the arrayed waveguide 24 and the first slab waveguide 23. The multiplexed light is outputted from one of the optical input waveguides 22.

For instance, as indicated in FIG. 16B, when a plurality of light having wavelengths of λ₁, λ₂, λ₃, - - - , λₙ (symbol “n” being integer larger than, or equal to 2) are inputted from the respective optical input waveguides 22, these plural lights having the different wavelengths are multiplexed with each other by the arrayed waveguide 24, and the second slab waveguide 25 via the first slab waveguide 23, and then, the multiplexed light is outputted from one of the output waveguides 26.

In the above-described arrayed waveguide grating, for example, as a plurality of light having wavelengths of λ₁, λ₂, λ₃, - - - , λₙ (symbol “n” being integer larger than, or equal to 2) are inputted from the respective optical input waveguides 22, these plural lights having the different wavelengths are multiplexed. In this case, an optical transmission characteristic (namely, wavelength characteristic of transmission light intensity of arrayed waveguide grating) of the light which is outputted from one of the optical output waveguides 26 may become, for example, such a characteristic shown in FIG. 17.

It should be understood that FIG. 17 represents an optical spectrum of an arrayed waveguide grating which is designed for optical multiplexing operation as to an interval of 100 GHz (namely, approximately 0.8 nm in wavelength) and 40 channels. This arrayed waveguide grating has already been available in the actual field. This optical spectrum shown in FIG. 17 owns 40 peaks. The transmittance is gradually decreased while the wavelength is shifted from optical transmission center wavelengths λ1, λ₂, λ₃, - - - , λ₄₀ corresponding to the respective peaks.

As previously explained, the circuit of the arrayed waveguide grating may play an important role in order to realize the high-density wavelength division multiplexing transmission.

However, in order that a high-density wavelength division transmission system may be realized in higher density, both wavelength-multiplexing operation and wavelength-demultiplexing operation are necessarily required with maintaining narrower wavelength intervals such as approximately 0.4 nm or approximately 0.2 nm. Under such a condition, the above-explained requirements can be hardly satisfied by employing such a circuit of a single arrayed waveguide grating.

To satisfy the above-described requirements, interleaver type optical wavelength multiplexers/demultiplexers with employment of a so-called interleaver system have been recently developed. In this interleaver system, wavelength-multiplexed light is multiplexed and/or demultiplexed in order that both wavelength-multiplexing operation and the wavelength-demultiplexing operation can be carried out with maintaining the above-explained narrower wavelength interval.

This interleaver type optical wavelength multiplexer/demultiplexer may multiplex such wavelength-multiplexed light having a plurality of different wavelengths in the same setting wavelength intervals, as indicated in FIG. 18A and FIG. 18B, during the wavelength multiplexing operation. In this case, as represented by an arrow “A” directed from FIG. 18A and FIG. 18B to FIG. 18C, the wavelength-multiplexed light shown in FIG. 18A is multiplexed with the wavelength-multiplexed light indicated in FIG. 18B so as to obtain such wavelength-multiplexed light as shown in FIG. 18C. In this example, the new wavelengths shown in FIG. 18A are inserted into the existing wavelengths shown in FIG. 18B.

Since the above-described wavelength-multiplexing operation is carried out, the wavelength-multiplexed light having the wavelengths of λ₁, λ₃, λ₅, λ₇, λ₉, λ₁₁, - - - , is multiplexed with the wavelength-multiplexed light having the wavelengths of λ₂, λ₄, λ₆, λ₈, λ₁₀ - - - . As a result of this multiplexing operation, such wavelength-multiplexed light having wavelengths of λ₁, λ₂, λ₃, λ₄, λ₅, λ₆, λ₇, λ₈, λ₉, λ₁₀, λ₁₁, - - - , may be formed.

As explained above, the interleaver type optical wavelength multiplexer/demultiplexer inserts such wavelengths which are shifted by offset values while maintaining the same wavelength intervals with respect to the wavelength-multiplexed light which has been multiplexed in a constant optical frequency interval (namely, constant wavelength interval). As a consequence, the interleaver type optical wavelength multiplexer/demultiplexer can increase the wavelength multiplexing density.

Also, in the wavelength- demultiplexing operation, the interleaver type optical wavelength multiplexer/demultiplexer demultiplexes such wavelength-multiplexed light shown in FIG. 18C into the wavelength-multiplexed light represented in FIG. 18A and 18B as indicated by another arrow “B” directed from FIG. 18C to both FIG. 18A and FIG. 18B.

Since this wavelength-demultiplexing operation is carried out, the interleaver type optical wavelength multiplexer/demultiplexer demultiplexes, for example, such wavelength-multiplexed light having the wavelengths of λ₁, λ₂, λ₃, λ₄, λ₅, λ₆, λ₇, λ₈, λ₉, λ₁₀, λ₁₁, - - - , into both the wavelength-multiplexed light having the wavelengths of λ₁, λ₃, λ₅, λ₇, λ₉, λ₁₁, - - - , and the wavelength-multiplexed light having the wavelengths of λ₂, λ₄, λ₈, λ₁₀, - - - .

As the above-explained interleaver type optical wavelength multiplexer/demultiplexer, the following multiplexers/demultiplexers have been proposed. That is, optical wavelength multiplexers/demultiplexers are realized by employing an FBG(Fiber Bragg Grating), a fiber type coupler, a PLC(Planar Lightwave Circuit) having an optical multiplexing/demultiplexing circuit, or the like. It should be understood that the interleaver type optical wavelength multiplexer/demultiplexer using the PLC may be expectedly manufactured in a mass production manner in view of integration characteristics thereof.

FIG. 19 indicates an example of such a circuit which is formed in an interleaver type optical wavelength multiplexer/demultiplexer using a PLC. The circuit indicated in FIG. 19 contains a circuit structural example of an optical multiplexing/demultiplexing circuit 8 of a Mach-Zehnder optical interferometer.

In FIG. 19, the optical multiplexing/demultiplexing circuit 8 contains a first optical waveguide 3 and a second optical waveguide 4 arranged side by side with respect to this first optical waveguide 3. Also, this optical multiplexing/demultiplexing circuit 8 contains a first directional coupling portion 11 constituted by positioning the first optical waveguide 3 in proximity to the second optical waveguide 4, and also a second directional coupling portion 12 constituted by positioning the first optical waveguide 3 in proximity to the second optical waveguide 4.

The first directional coupling portion 11 and the second directional coupling portion 12 are arranged via an interval along a longitudinal direction of the optical waveguides. Both a length of the first optical waveguide 3 and a length of the second optical waveguide 4 at a phase portion (phase applying portion) are made different from each other, which are sandwiched between the first directional coupling portion 11 and the second directional coupling portion 12.

It should be understood that the optical multiplexing/demultiplexing circuit 8 shown in FIG. 19 is constituted by arranging the two directional coupling portions 11 and 12 constituted by positioning the first optical waveguide 3 in proximity to the second optical waveguide 4 via the interval along the longitudinal direction of the optical waveguides. However, the circuit of the Mach-Zehnder optical interferometer described in this specification implies such a circuit arrangement. That is, while a plurality of directional coupling portions are arranged via an interval along a longitudinal direction of optical waveguides, both a length of a first optical waveguide and a length of a second optical waveguide, which are sandwiched between adjacent directional coupling portions, are made different from each other.

In other words, the optical multiplexing/demultiplexing circuit of the Mach-Zehnder optical interferometer described in this specification includes three sets, or more sets of directional coupling portions.

The optical multiplexing/demultiplexing circuit 8 shown in FIG. 19 owns the below-mentioned function by properly setting such a product (nₑ×ΔL) defined by a difference “L” between the length of the first optical waveguide 3 and the length of the second optical waveguide 4, which are sandwiched between both the first directional coupling portion 11 and the second directional coupling portion 12, and also such refractive indexes “nₑ” (namely, effective refractive indexes of waveguide cores) of both the first and second optical waveguides 3 and 4. This function may multiplex lights having different wavelengths with each other, and conversely, may demultiplex wavelength-multipled light to obtain lights having respective wavelengths.

Since the optical multiplexing/demultiplexing circuit 8 of the Mach-Zehnder optical interferometer owns the periodic pass-band characteristic, this optical multiplexing/demultiplexing circuit 8 may be suitably used as such a circuit of an optical wavelength multiplexer/demultiplexer to which an interleaver is applied, which is practically used. FIG. 20 shows such an example that while the circuit of the Mach-Zehnder optical interferometer shown in FIG. 19 is employed, wavelength-multiplexed light having wavelengths of λ₁, λ₃, λ₅, - - - , λₙ₋₁ is multiplexed with wavelength-multiplexed light having wavelengths of λ₂, λ₄, - - - , λₙ.

In such a case that an interleaver type optical wavelength multiplexer/demultiplexer containing this Mach-Zehnder optical interferometer circuit is combined with the circuit of the arrayed waveguide grating shown in FIG. 16A and FIG. 16B so as to form an optical wavelength multiplexer/demultiplexer, such an idea may be conceived. For instance, while such a circuit arrangement as shown in FIG. 15 is formed, this circuit is formed on a single substrate.

The circuit arrangement indicated in FIG. 15 implies that while the circuit of the Mach-Zehnder optical interferometer is used as the optical multiplexing/demultiplexing circuit 8(8C), such a circuit is formed on the same substrate, in which the optical multiplexing/demultiplexing circuits 8(8A, 8B) of the arrayed waveguide gratings are formed on both the input side of the first optical waveguide 3 and the input side of the second optical waveguide 4 in this optical multiplexing/demultiplexing circuit 8(8C), respectively.

### SUMMARY OF THE INVENTION

An optical wavelength multiplexer/demultiplexer, according to the present invention, is featured by comprising:

a plurality of optical waveguide circuit chips in which optical multiplexing/demultiplexing circuits having wavelength multiplexing/demultiplexing functions, which are formed by optical waveguides, are formed on substrates different from each other; in which:

the plurality of optical waveguide circuit chips are connected to each other so as to be coupled in a multiple stage.

### BRIEF DESCRIPTION OF THE DRAWINGS

Exemplary embodiments of the invention will now be described in conjunction with drawings, in which:

FIG. 1 is an essential-part structural view for indicating an optical wavelength multiplexer/demultiplexer according to a first embodiment of the present invention;

FIG. 2 is an explanatory view for representing a planar structure of the above-described first embodiment;

FIG. 3 is a graph for graphically indicating a transmission spectrum of the first embodiment;

FIG. 4 is an essential-part structural view for showing an optical wavelength multiplexer/demultiplexer according to a second embodiment of the present invention;

FIG. 5 is an explanatory view for indicating a planar structure of one optical multiplexing/demultiplexing circuit which constitutes the above-described second embodiment;

FIG. 6 is a graph for graphically showing a transmission spectrum of the second embodiment;

FIG. 7 is an essential-part structural view for showing an optical wavelength multiplexer/demultiplexer according to a third embodiment of the present invention;

FIG. 8A and FIG. 8B are explanatory views for indicating a planar structure of one optical multiplexing/demultiplexing circuit which constitutes the above-described third embodiment;

FIG. 9 is a graph for graphically showing a transmission spectrum of the third embodiment;

FIG. 10 is a graph for graphically showing a transmission spectrum of a comparison example 1;

FIG. 11 is an explanatory view for representing an optical wavelength multiplexer/demultiplexer of the comparison example 1;

FIG. 12 is an essential-part structural view for showing an optical wavelength multiplexer/demultiplexer according to a fourth embodiment of the present invention;

FIG. 13 is a graph for graphically showing a transmission spectrum of the fourth embodiment;

FIG. 14 is a graph for graphically showing a transmission spectrum of a comparison example 2;

FIG. 15 is an explanatory view for representing an optical wavelength multiplexer/demultiplexer of the comparison example 2;

FIG. 16A is an explanatory view for indicating a circuit structural example of an arrayed waveguide grating in connection with demultiplexing operation thereof;

FIG. 16B is an explanatory view for showing a circuit structural example of an arrayed waveguide grating in connection with multiplexing operation thereof;

FIG. 17 is a graph for graphically shows an example of a transmission spectrum of the arrayed waveguide grating;

FIG. 18A, FIG. 18B, and FIG. 18C are schematic diagrams of wavelength-multiplexed light used to typically explain multiplex/demultiplex structures of wavelength-multiplexed light so as to increase a communication capacity;

FIG. 19 is an explanatory view for indicating an optical multiplexing/demultiplexing circuit of a Mach-Zehnder optical interferometer;

FIG. 20 is an explanatory view for showing an example of multiplexing operation of wavelength-multiplexed light with employment of the optical multiplexing/demultiplexing circuit shown in FIG. 19;

FIG. 21A and FIG. 21B are explanatory diagrams for representing each of circuit arrangements on which plural sets of optical multiplexing/demultiplexing circuits of the Mach-Zehnder optical interferometer are formed on the same substrate;

FIG. 22 is an explanatory view for showing an example of multiplexing operation of wavelength-multiplexed light with employment of the optical multiplexing/demultiplexing circuit shown in FIG. 21B;

FIG. 23A is a graph for graphically showing a change amount of optical transmission center wavelengths in the case that a value of 10⁻⁵ digit of an equivalent index can be controlled in the optical multiplexing/demultiplexing circuit of the Mach-Zehnder optical interferometer; and

FIG. 23B is a graph for graphically showing a change amount of optical transmission center wavelengths in the case that a value of 10⁻⁵ digit of an equivalent index cannot be controlled in the optical multiplexing/demultiplexing circuit of the Mach-Zehnder optical interferometer.

### DETAILED DESCRIPTION

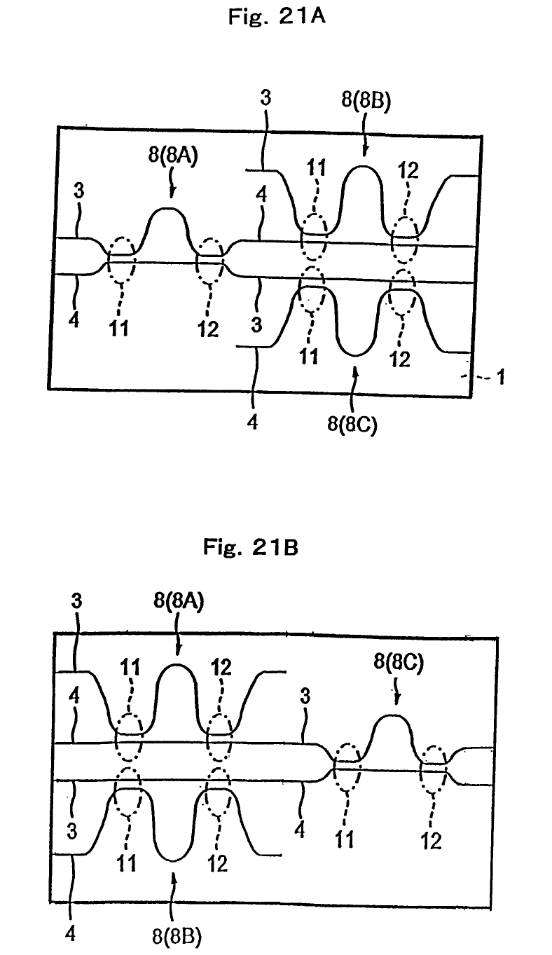

As to interleaver type optical wavelength multiplexers/demultiplexers, the following aspects are desirably required. That is, while isolation in proximity wavelengths is increased, adjacent crosstalk is decreased. In order to improve characteristics of such interleaver type optical wavelength multiplexers/demultiplexers, interleaver type optical wavelength multiplexers/demultiplexers shown in FIG. 21A and FIG. 21B have been proposed.

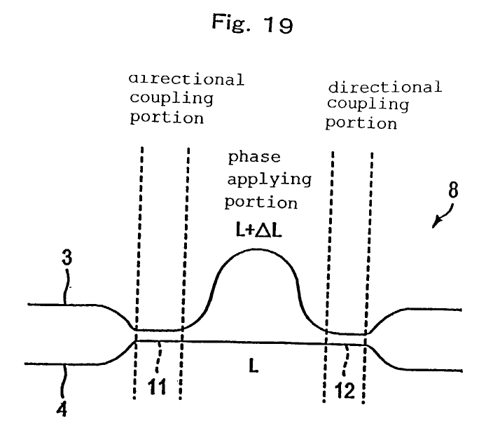

This optical wavelength multiplexer/demultiplexer is constructed in such a manner that plural sets (three sets in this case) of the optical multiplexing/demultiplexing circuits 8 indicated in FIG. 19 are connected to each other so as to form an optical multiplexing/demultiplexing circuit having a multi-staged structure, and then, this circuit is formed on a single substrate 1.

In the optical wavelength multiplexers/demultiplexers shown in FIG. 21A and FIG. 21B, since the optical transmission center wavelengths which are multiplexed/demultiplexed by the optical multiplexing/demultiplexing circuits 8 (namely, 8A, 8B, 8C) provided in the respective stages are made equal to designed wavelengths, the isolation of the optical wavelength multiplexers/demultiplexers can be increased by approximately 15 dB, as compared with a single stage of the optical multiplexing/demultiplexing circuit 8 shown in FIG. 19.

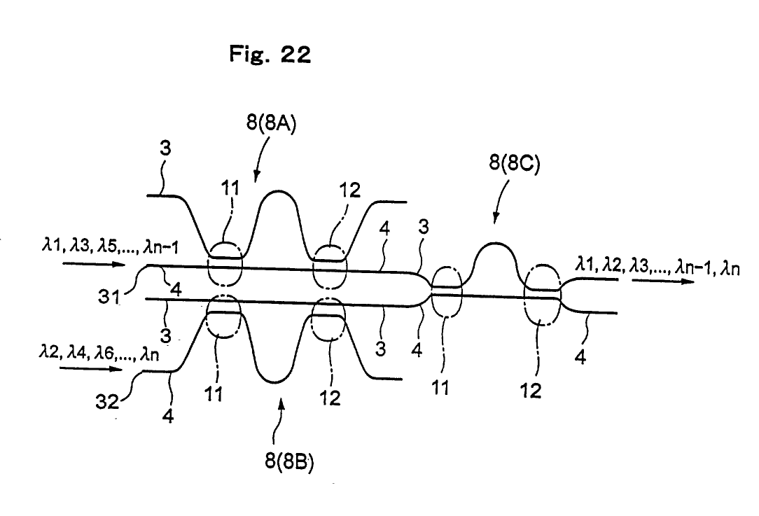

As a consequence, for instance, when wavelength-multiplexed light is multiplexed as indicated in FIG. 22 by employing the optical wavelength multiplexer/demultiplexer shown in FIG. 21B, adjacent crosstalk of the wavelength-multiplexed light which is multiplexed to be outputted can be improved, as compared with the adjacent crosstalk of the optical multiplexing/demultiplexing circuit 8 denoted in FIG. 19.

FIG. 22 represents such an example that while wavelength-multiplexed light having wavelengths of λ₁, λ₃, λ₅, - - - , λₙ₋₁ are inputted from an optical input portion 31, and also, wavelength-multiplexed light having wavelengths Of λ₂, λ₄, λ₆, - - - , λₙ are entered from an optical input portion 32, both the wavelength-multiplexed light is multiplexed with each other to output such light having wavelengths of λ₁, λ₂, λ₃, - - - , λₙ₋₁, and λₙ.

On the other hand, in the circuit of the Mach-Zehnder optical interferometer, and the circuit of above-explained arrayed waveguide grating, an optical transmission center wavelength “λ₀” of light which is multiplexed/demultiplexed is expressed based upon the following formula (1):

### Formula 1

λ₀=n_{c}ΔL/m,

where symbol “n_{c}” shows an equivalent index of an optical waveguide core which forms a phase applying portion, symbol “ΔL” represents a difference between waveguides which constitute the phase applying portion, and symbol “m” shows a diffraction order.

As apparent from this formula (1), when the equivalent index “nₙ” of the optical waveguide core which constitutes the above-described phase applying portion is shifted from the designed value thereof, the optical transmission center wavelength is also shifted by receiving the adverse influence caused by this shift of the equivalent index. It should be noted that the phase applying portion of the optical multiplexing/demultiplexing circuit 8 shown in FIG. 19 corresponds to both a first optical waveguide 3 and a second optical waveguide 4, which are sandwiched between both a first directional coupling portion 11 and a second directional coupling portion 12.

However, since the equivalent index “n_{c}” of the optical waveguide core depends upon a processed shape of the optical waveguide, and a fluctuation of local refraction indexes thereof, it is practically difficult to completely stabilize the value of the equivalent refractive index “n” of the waveguide core, so that manufacturing errors may easily occur. As a consequence, the optical transmission center wavelength may be sometimes shifted by receiving the adverse influence caused by the manufacturing error of the equivalent index.

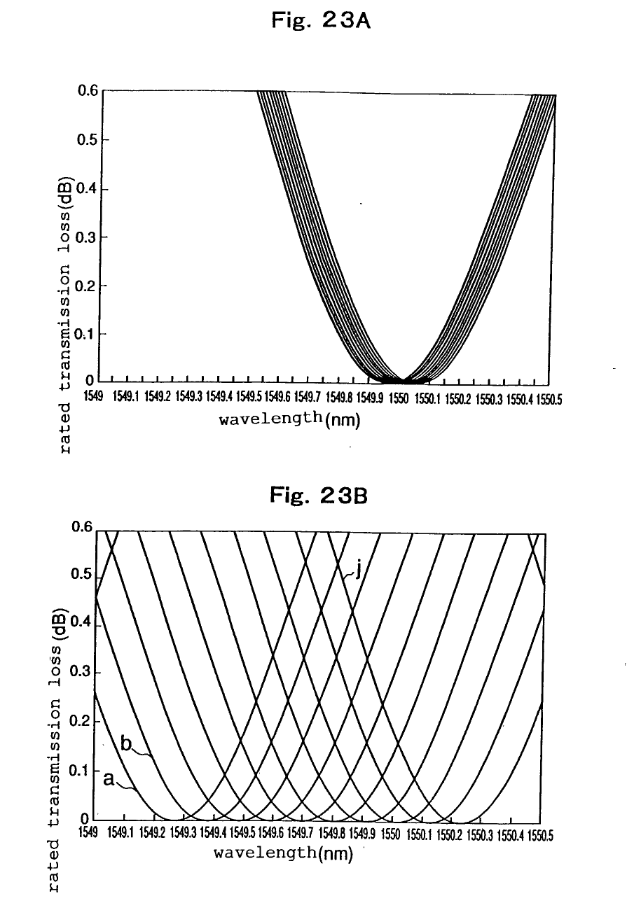

For example, if the digit 10⁻⁵ of the equivalent index as to the phase applying portion of the optical multiplexing/demultiplexing circuit 8 can be correctly formed, then the optical transmission center wavelength which is multiplexed/demultiplexed by the optical multiplexing/demultiplexing circuit 8 of the Mach-Zehnder optical interferometer is not substantially shifted, as represented in FIG. 23A. However, if the digit 10⁻⁵ of the above-described equivalent index cannot be correctly formed, then this optical transmission center wavelength is largely shifted, as indicated in FIG. 23B. In accordance with the normal manufacturing technique, digits of an equivalent index up to the digit 10⁻⁵ can be very hardly manufactured in a correct manner.

It should be understood that when the digit 10⁻⁴ of the equivalent index of the phase applying portion of the optical multiplexing/demultiplexing circuit 8 is shifted from 0 to 1, a transmission loss/wavelength characteristic of this optical multiplexing/demultiplexing circuit 8 is shifted from a characteristic line “a” to another characteristic line “b” of FIG. 23B. Also, when the digit 10⁻⁴ of the equivalent index of the phase applying portion of the optical multiplexing/demultiplexing circuit 8 is shifted from 0 to 9, a transmission loss/wavelength characteristic of this optical multiplexing/demultiplexing circuit 8 is shifted from the characteristic line “a” to another characteristic line “j” of FIG. 23B, so that the optical transmission center wavelength is shifted by a value larger than, or equal to 1.0 nm.

In the optical wavelength multiplexers/demultiplexers shown in FIG. 21A and FIG. 21B, it is practically difficult that all of the optical transmission center wavelengths of these optical multiplexing/demultiplexing circuits 8(8A, 8B, 8C) provided in the respective stages are made substantially identical to the predetermined wavelengths. As a consequence, in the optical wavelength multiplexers/demultiplexers shown in FIG. 21A and FIG. 21B, caused by the shift of the optical transmission center wavelengths of the respective optical multiplexing/demultiplexing circuit 8(8A, 8B, 8C), the transmission losses of the entire circuit were increased, and the signal separation performance (namely, crosstalk) with respect to the adjacent channels was deteriorated.

As a consequence, as to the optical wavelength multiplexers/demultiplexers indicated in FIG. 21A and FIG. 21B, the below-mentioned measures have been proposed. In accordance with the proposed measures, after the optical wavelength multiplexers/demultiplexers have been formed, phase trimming operation of the respective optical multiplexing/demultiplexing circuits 8(8A, 8B, 8C) is carried out so as to compensate for such shifts of the optical transmission center wavelengths from the designed wavelengths, while the optical transmission center wavelengths are multiplexed/demultiplexed by the respective optical multiplexing/demultiplexing circuits 8(8A, 8B, 8C). However, the phase trimming operation owns such a problem that this phase trimming operation can be hardly controlled.

In other words, the above-described phase trimming operation is carried out by irradiating laser light to an optical waveguide, and by forming a thin-film heater onto a phase applying portion. Since all of these operations are performed in a pin-point manner with respect to the above-explained phase applying portion, control operations thereof can be very hardly carried out. Also, in order to execute these phase trimming operations, a large-scaled facility such as laser is required. Furthermore, since the phase trimming operation is carried out while on-line measuring operation is performed, the trimming steps become complex and the optical multiplexing/demultiplexing circuit can be hardly manufactured in a mass production manner.

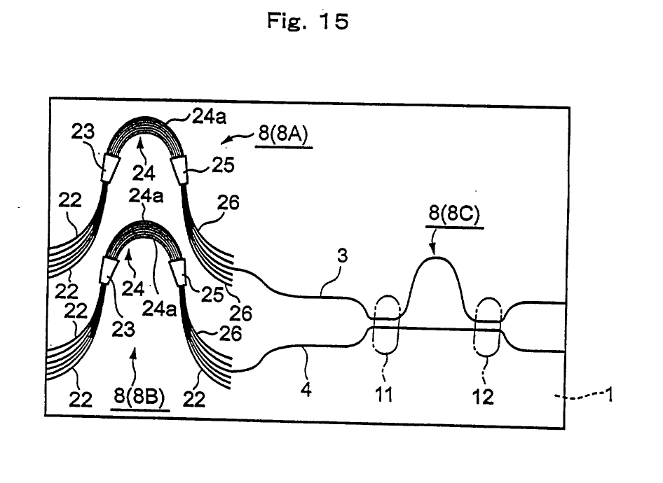

Then, the above-described problem may similarly occur in such an optical wavelength multiplexer/demultiplexer. That is, as indicated in FIG. 15, in this optical wavelength multiplexer/demultiplexer, both the circuit of the arrayed waveguide grating and the circuit of the Mach-Zehnder optical interferometer are formed on the same substrate. In other words, such an optical wavelength multiplexer/demultiplexer owns a problem similar to the above-explained problem, in which a circuit manufactured by connecting multi-stages of the Mach-Zehnder optical interferometer circuits to multi-stages of the arrayed waveguide grating circuits is provided on the same substrate. As a result, development as to such an optical wavelength multiplexer/demultiplexer has been eagerly desired, while this optical wavelength multiplexer/demultiplexer can multiplex and/or demultiplex such light having very narrow wavelength intervals with maintaining low adjacent crosstalk and low transmission loss.

One aspect of an optical wavelength multiplexer/demultiplexer according to the present invention is such an easily-manufactured optical wavelength multiplexer/demultiplexer capable of obtaining an optical characteristic substantially equal to a designed characteristic, while having a low transmission loss and a low adjacent crosstalk.

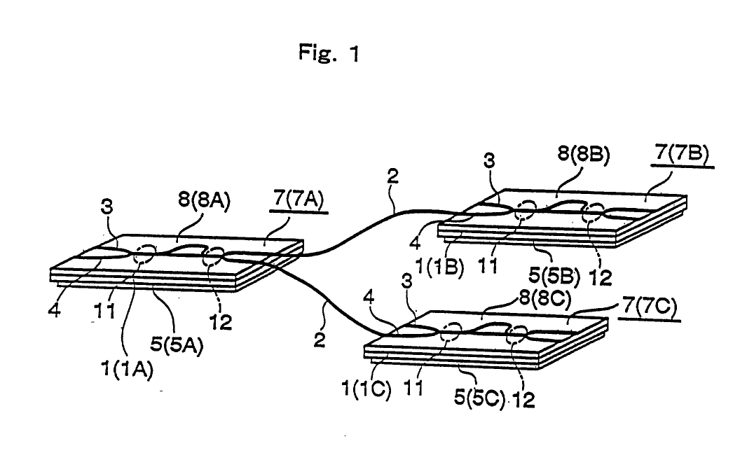

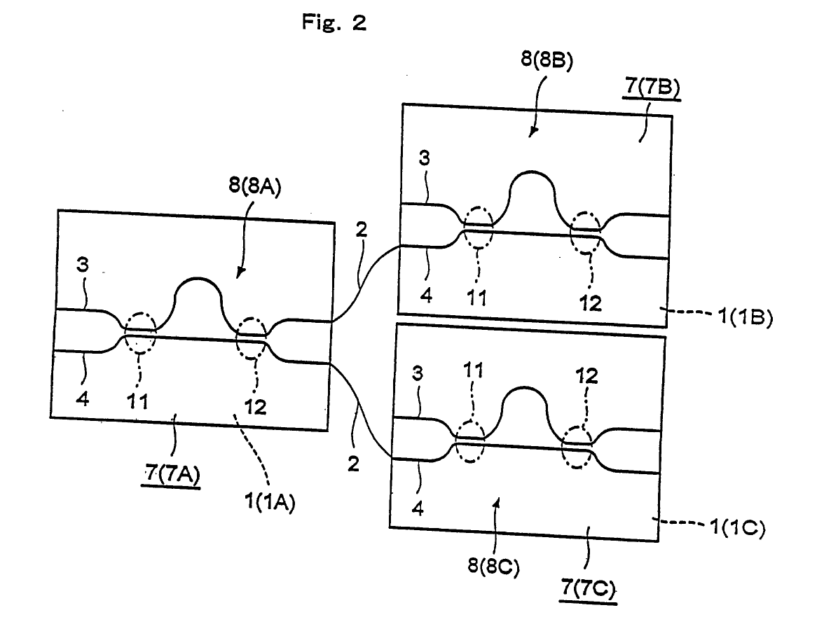

Referring now to drawings, various embodiments of the present invention will be described. It should be noted that in the below-mentioned descriptions, the same reference numerals as shown in the prior art will be employed as those for indicating the same, or similar structural portions of the below-mentioned embodiments, and therefore, descriptions thereof are omitted, or will be simply made. FIG. 1 is an essential-part structural view for indicating an optical wavelength multiplexer/demultiplexer according to a first embodiment of the present invention. FIG. 2 is a plan view of this optical wavelength multiplexer/demultiplexer.

As indicated in FIG. 1 and FIG. 2, the optical wavelength multiplexer/demultiplexer of this first embodiment is manufactured by connecting plural sets (three sets in this embodiment) of optical waveguide circuit chips 7 (namely, circuit chips 7A, 7B, 7C). Each of the plural optical waveguide circuit chips 7(7A, 7B and 7C), is constituted in such a manner that optical multiplexing/demultiplexing circuits 8(8A, 8B and 8C) of Mach-Zehnder optical interferometers are separately formed on substrates 1 (namely, substrates 1A, 1B and 1C) different from each other. The optical multiplexing/demultiplexing circuit 8(8A, 8B and 8C) are formed by circuits of optical waveguides.

In accordance with the first embodiment, since the optical multiplexing/demultiplexing circuits 8(8A, 8B, 8C) are formed by employing the circuits of the Mach-Zehnder optical interferometers, such an optical wavelength multiplexer/demultiplexer can be correctly arranged, by which light having a plurality of wavelengths can be multiplexed and/or demultiplexed in a narrow wavelength interval.

While the optical waveguide circuit chip 7A is connected via an optical fiber 2 to the optical waveguide circuit chip 7B, the optical fiber 2 is connected to both the optical waveguide circuit chips 7A and 7B by using UV (ultraviolet) hardening adhesive agent. Similarly, while the optical waveguide circuit chip 7A is connected via an optical fiber 2 to the optical waveguide circuit chip 7C, the optical fiber 2 is connected to both the optical waveguide circuit chips 7A and 7C by using the UV (ultraviolet) hardening adhesive agent.

Also, temperature control means 5 (namely, temperature control means 5A, 5B and 5C) are provided on the respective optical waveguide circuit chips 7(7A, 7C, 7C), while the temperature control means 5 control a temperature as to each of the optical waveguide circuit chips 7(7A, 7B, 7C), and thus, adjust optical transmission center wavelengths of the corresponding optical multiplexing/demultiplexing circuits.

In general, an optical waveguide for forming an optical multiplexing/demultiplexing circuit is manufactured by a silica-based waveguide. Also, in this first embodiment, the optical waveguides for forming the optical multiplexing/demultiplexing circuits 8(8A, 8B, 8C) correspond to silica-based waveguides. An optical transmission center wavelength of such a silica-based waveguide may have such a temperature depending characteristic as shown in the following formula (2):

$$\frac{ⅆ λ}{ⅆ T} = \frac{λ \partial {n}_{Ϛ}}{{n}_{c} \partial T} + λ \cdot α \approx 0.01 [ nm \text{/} °C . ] . \qquad ( Formula 2 )$$

In this formula (2), symbol “λ” shows a wavelength, symbol “T” represents a temperature, symbol “n_{c}” shows an equivalent index of a waveguide core, and symbol “α” indicates an expansion coefficient of a substrate.

As previously explained, the optical transmission center wavelength of the silica-based waveguide is shifted by approximately 0.01 nm in response to a temperature change by 1° C. In this first embodiment, while this temperature depending characteristic is utilized, the optical transmission center wavelengths of the optical multiplexing/demultiplexing circuits 8(8A, 8B, 8C) may be adjusted. In other word, this first embodiment is featured by that the temperature control means 5 (namely, temperature control means 5A, 5B and 5C) are provided on the respective optical waveguide circuit chips 7(7A, 7B, 7C), while the temperature control means 5 control a temperature as to each of the optical waveguide circuit chips 7(7A, 7B, 7C), and thus, adjust optical transmission center wavelengths of the corresponding optical multiplexing/demultiplexing circuits 8(8A, 8B, 8C).

In this first embodiment, the temperature control means 5(5A, 5B, 5C) are formed by heaters. Each of these temperature control means 5(5A, 5B, 5C) is arranged in such a manner that the optical transmission center wavelength of the corresponding optical multiplexing/demultiplexing circuit 8(8A, 8B, 8C) is made substantially coincident with the predetermined wavelength.

That is to say, in the first embodiment, the temperature control means 5A maintains the temperature of the optical waveguide circuit chip 7A at 85° C. The temperature control means 5B maintains the temperature of the optical waveguide circuit chip 7B at 90° C. The temperature control means 5C maintains the temperature of the optical waveguide circuit chip 7C at 75° C. The temperature control means 5(5A, 5B, 5C) are arranged in such a manner that the optical transmission center wavelengths of the corresponding optical multiplexing/demultiplexing circuits 8(8A, 8B, 8C) may be made substantially coincident with the predetermined wavelengths by way of these temperature controls.

It should be noted that an FSR (free spectrum range) of each of the optical multiplexing/demultiplexing circuits 8(8A, 8B, 8C) is designed as 200 GHz. The optical multiplexing/demultiplexing circuits 8(8A, 8B, 8C) are designed in such a manner that light entered in an interval of 100 GHz is subdivided into light in an interval of 200 GHz. Also, all of coupling efficiencies of the first directional coupling portion 11 and the second directional coupling portion 12 in the respective optical multiplexing/demultiplexing circuits 8(8A, 8B, 8C) are nearly equal to 50%.

Also, the above-described substrates 1(1A, 1B, 1C) are manufactured by silicon substrates. A relative refractive index difference “Δ” of the cores which forms the optical multiplexing/demultiplexing circuits 8(8A, 8B, 8C) is 0.8%. A sectional dimension of a core is equal to 6.5 μm×6.5 μm.

The optical wavelength multiplexer/demultiplexer according to the first embodiment is constituted with employment of the above-described structure. Now, manufacturing steps of this optical wavelength multiplexer/demultiplexer of this first embodiment will be described. First, the optical waveguide circuit chips 7(7A, 7B, 7C) are manufactured in accordance with the below-mentioned manufacturing steps. That is, the optical multiplexing/demultiplexing circuits 8(8A, 8B, 8C) corresponding thereto are formed on the respective substrates 1(1A, 1B, 1C).

A first manufacturing step of the optical waveguide circuit chips 7(7A, 7B, 7C) corresponds to such a step that films of both an under cladding layer and a core layer are formed on the respective silicon substrates 1(1A, 1B, 1C) by employing the flame hydrolysis deposition (FHD) method and are sintered.

A second manufacturing step corresponds to such a step that a pattern of a core containing each of the optical multiplexing/demultiplexing circuits 8(8A, 8B, 8C) is transferred by using the photolithography technique. A third manufacturing step corresponds to such a step that the core is processed in accordance with the pattern which has been transferred in the above-described second step by employing the reactive ion etching (RIE) method. A fourth manufacturing step corresponds to such a step that an over cladding layer is formed by employing the flame hydrolysis deposition (FHD) method, a waveguide core is embedded, and thereafter, the resulting chip is sintered to obtain transparent glass.

After the above-described optical waveguide circuit chips 7(7A, 7B, 7C) are manufactured, the Inventors of the present invention measured optical transmission center wavelengths of the optical multiplexing/demultiplexing circuits 8(8A, 8B, 8C) at a predetermined temperature (for example, 25° C.) with respect to each of the optical waveguide circuit chips 7(7A, 7B, 7C).

As a result of this measurement, the following fact can be revealed. That is, with respect to the predetermined wavelength of 1550.9 nm used as a grid, the respective optical transmission center wavelengths of the optical multiplexing/demultiplexing circuits 8(8A, 8B, 8C) are shifted as follows: In other words, the optical transmission center wavelength of the optical multiplexing/demultiplexing circuit 8A was shifted to a short wavelength side by 0.6 nm. Also, the optical transmission center wavelength of the optical multiplexing/demultiplexing circuit 8B was shifted to a short wavelength side by 0.65 nm. Also, the optical transmission center wavelength of the optical multiplexing/demultiplexing circuit 8C was shifted to a short wavelength side by 0.5 nm.

As previously described, the temperature depending characteristic of the optical transmission center wavelength of the silica-based waveguide is 0.01 nm/° C. As a consequence, in order that the optical transmission center wavelengths of the respective optical multiplexing/demultiplexing circuits 8(8A, 8B, 8C) are made coincident with the predetermined wavelengths, the temperature of the optical multiplexing/demultiplexing circuit 8A may be set to 85° C. Also, the temperature of the optical multiplexing/demultiplexing circuit 8B may be set to 90° C. Also, the temperature of the optical multiplexing/demultiplexing circuit 8C may be set to 75° C.

As a consequence, as indicated in FIG. 1 and FIG. 2, in the first embodiment, the optical transmission center wavelengths of the corresponding optical multiplexing/demultiplexing circuits 8(8A, 8B, 8C) could be made substantially coincident with the predetermined wavelengths in such a manner that while the optical waveguide circuit chips 7(7A, 7B, 7C) are connected via the optical fiber 2 to each other, the temperature controls by the temperature control means 5(5A, 5B, 5C) are carried out.

In other words, the temperature control means 5A maintains the temperature of the optical waveguide circuit chip 7A at 85° C. Also, the temperature control means 5B maintains the temperature of the optical waveguide circuit chip 7B at 90° C. Also, the temperature control means 5C maintains the temperature of the optical waveguide circuit chip 7C at 75° C. Then, since these temperature control operations are carried out, the optical transmission center wavelengths of the corresponding optical multiplexing/demultiplexing circuits 8(8A, 8B, 8C) could be made substantially identical to the predetermined wavelengths in the first embodiment.

As previously described, while the shifts of the optical transmission center wavelengths of the optical multiplexing/demultiplexing circuits 8(8A, 8B, 8C) with respect to the predetermined wavelengths have been previously measured for each optical waveguide circuit chip 7A, the heating temperatures are determined based upon the measurement values, so that the shift amounts of the optical transmission center wavelengths from the predetermined wavelengths can be correctly compensated.

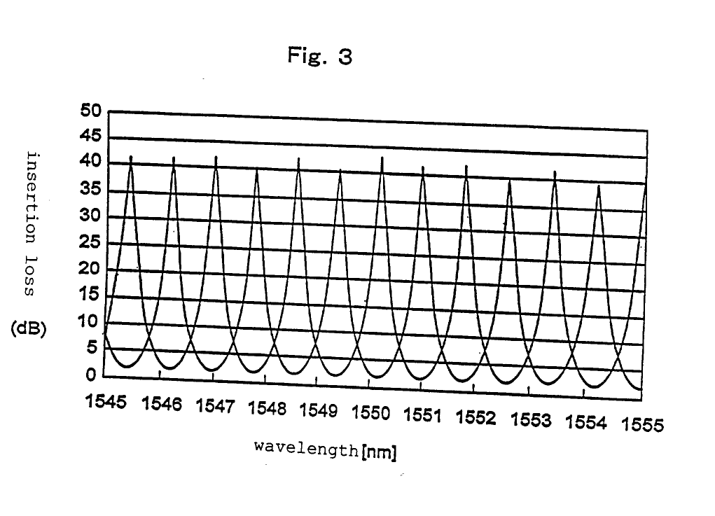

While the optical wavelength multiplexer/demultiplexer of the first embodiment has been constructed as described above, the transmission/wavelength characteristic of this optical wavelength multiplexer/demultiplexer according to the first embodiment could be represented in FIG. 3. In other words, as apparent from FIG. 3, the optical wavelength multiplexer/demultiplexer of this first embodiment could be realized as such an optical wavelength multiplexer/demultiplexer having such a transmission/wavelength characteristic that the insertion loss is approximately 2.5 dB, and the isolation is approximately 37 dB in the optical transmission center wavelengths.

As previously explained, in accordance with the first embodiment, while the optical transmission center wavelengths of the optical multiplexing/demultiplexing circuits 8(8A, 8B, 8C) can be adjusted, the optical wavelength multiplexer/demultiplexer capable of multiplexing and demultiplexing the light with maintaining the low loss and the low crosstalk, and also the high isolation can be realized. This optical wavelength multiplexer/demultiplexer may be realized as, for example, the interleaver type optical wavelength multiplexer/demultiplexer.

Also, in the first embodiment, the adjustment of the optical transmission center wavelengths by the above-described temperature control means 5(5A, 5B, 5C) may be carried out by merely heating the entire substrates of the respective optical waveguide circuit chips 7(7A, 7A, 7C). As a result, this wavelength adjustment can be correctly carried out in a very easy manner.

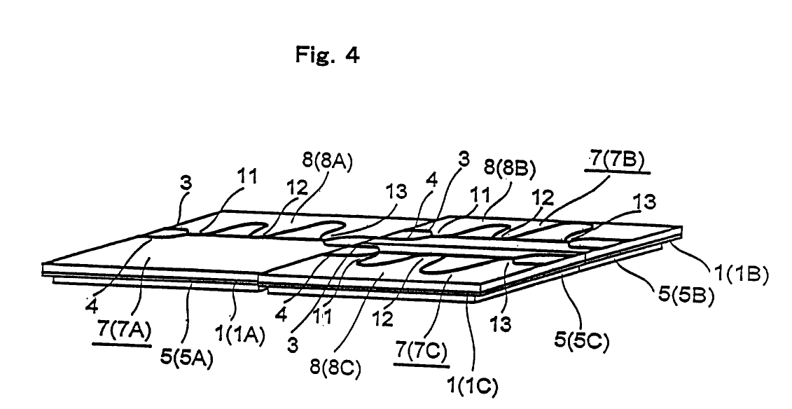

FIG. 4 is an essential-part structural view of an optical wavelength multiplexer/demultiplexer according to a second embodiment of the present invention, as a perspective view.

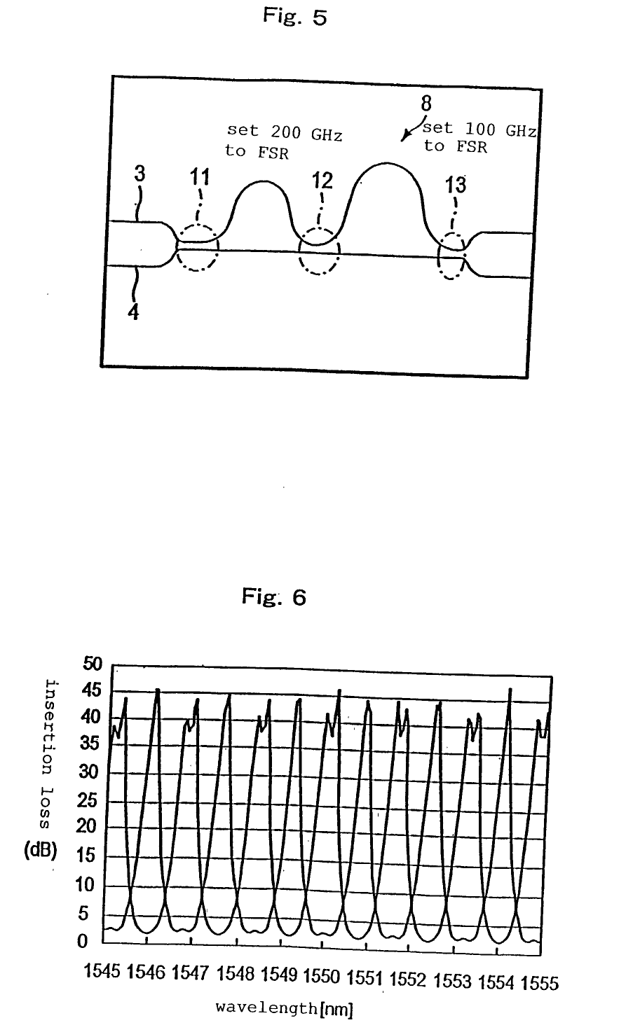

As represented in FIG. 5, the optical wavelength multiplexer/demultiplexer of the second embodiment is arranged in such a manner that optical multiplexing/demultiplexing circuits 8(8A, 8B, 8C) of Mach-Zehnder optical interferometers are formed on different substrates 1(1A, 1B, 1C) from each other so as to form a plurality of optical waveguide circuit chips 7(7A, 7B, 7C). In this case, three pieces of optical waveguide circuit chips 7 are formed. These plural optical waveguide circuit chips 7(7A, 7B, 7C) abut against each other and are connected to each other under such a condition that connection edge surfaces corresponding thereto are positioned opposite to each other.

In this optical wavelength multiplexer/demultiplexer of the second embodiment, structures of the optical multiplexing/demultiplexing circuits 8(8A, 8B, 8C) formed on the substrates 1(1A, 1B, 1C) are made different from the structures of the optical multiplexing/demultiplexing circuits 8(8A, 8B, 8C) employed in the first embodiment. Also, these optical multiplexing/demultiplexing circuits 8(8A, 8B, 8C) are connected to each other without via an optical fiber 2. Since structures of the second embodiment other than the above-described structures are similar to those of the first embodiment, explanations thereof are omitted, or will be simply made.

In the optical wavelength multiplexer/demultiplexer of the second embodiment, as indicated in FIG. 4 and FIG. 5, each of the optical multiplexing/demultiplexing circuits 8(8A, 8B, 8C) contains a first optical waveguide 3 and also a second optical waveguide 4 arranged side by side with respect to this first optical waveguide 3. Also, the optical multiplexing/demultiplexing circuits 8(8A, 8B, 8C) are manufactured in such a manner that a first directional coupling portion 11, a second directional coupling portion 12, and a third directional coupling portion 13, which are formed by proximating the first optical waveguide 3 to the second optical waveguide 4, are arranged with keeping intervals along a longitudinal direction of the optical waveguides. Furthermore, a length of the first optical waveguide 3 and a length of the second optical waveguide 4 are made different, which are sandwiched between the adjacent directional coupling portions 11, 12, and 13.

In this second embodiment, temperature control means 5 (namely, 5A, 5B, and 5C) are constructed of Peltier devices. The temperature control means 5A maintains the temperature of the optical waveguide circuit chip 7A at 44° C. Also, the temperature control means 5B maintains the temperature of the optical waveguide circuit chip 7B at 53° C. Also, the temperature control means 5C maintains the temperature of the optical waveguide circuit chip 7C at 55° C. In the second embodiment, the optical wavelength multiplexer/demultiplexer is so arranged in that the optical transmission center wavelengths of the corresponding optical multiplexing/demultiplexing circuits 8(8A, 8B, 8C) can be made substantially identical to the predetermined wavelengths by performing the temperature controls by the temperature control means 5(5A, 5B, 5C).

It should be noted that each FSR (free spectrum range) of the respective optical multiplexing/demultiplexing circuits 8(8A, 8B, 8C) is designed as 200 GHz at a place sandwiched between the directional coupling portion 11 and the directional coupling portion 12, and as 100 GHz at a place sandwiched between the directional coupling portion 12 and the directional coupling portion 13. A difference between a length of the first optical waveguide 3 and a length of the second waveguide 4 is approximately 1 mm, which are sandwiched between the first directional coupling portion 11 and the second directional coupling portion 12. A difference between a length of the first optical waveguide 3 and a length of the second waveguide 4 is approximately 2 mm, which are sandwiched between the second directional coupling portion 12 and the third directional coupling portion 13.

Also, in the respective optical multiplexing/demultiplexing circuits 8(8A, 8B, 8C), a coupling efficiency of the first directional coupling portion 11 is nearly equal to 50%; a coupling efficiency of the second directional coupling portion 12 is nearly equal to 70%; and a coupling efficiency of the third directional coupling portion 13 is nearly equal to 10%. The arrangements of the above-described each FSR, the difference between the length of the first and second optical waveguides 3 and 4, and also, the coupling efficiencies thereof are designed in such a manner that the light entered at the interval of 100 GHz is subdivided by the interval of 200 GHz by the optical multiplexing/demultiplexing circuits 8(8A, 8B, 8C).

While the optical wavelength multiplexer/demultiplexer of the second embodiment is constituted by employing the above-explained structure, this optical wavelength multiplexer/demultiplexer according to the second embodiment may be manufactured in a substantially same manner as that of the above-described optical wavelength multiplexer/demultiplexer of the first embodiment.

With respect of the manufacturing steps of the second embodiment, the Inventors of the present invention measured optical transmission center wavelengths of the optical multiplexing/demultiplexing circuits 8(8A, 8B, 8C) at a predetermined temperature (for example, 25° C.) as to each of the optical waveguide circuit chips 7(7A, 7B, 7C) manufactured in the separate manner. As a result of this measurement, the following fact can be revealed. That is, with respect to the predetermined wavelength of 1550.9 nm used as a grid, the optical transmission center wavelength of the optical multiplexing/demultiplexing circuit 8A was shifted to a short wavelength side by 0.19 nm. Also, the optical transmission center wavelength of the optical multiplexing/demultiplexing circuit 8B was shifted to a short wavelength side by 0.28 nm with respect to the setting wavelength of 1550.9 nm. Also, the optical transmission center wavelength of the optical multiplexing/demultiplexing circuit 8C was shifted to a short wavelength side by 0.3 nm as to the predetermined wavelength of 1550.9 nm.

Under such circumstances, in accordance with the second embodiment, considering the temperature depending characteristic as to the optical transmission center wavelengths of the silica-based waveguides, the optical transmission center wavelengths of the corresponding optical multiplexing/demultiplexing circuits 8(8A, 8B, 8C) are made substantially identical to the predetermined wavelengths by the temperature control means 5(5A, 5B, 5C).

In other words, the temperature control means 5A maintains the temperature of the optical waveguide circuit chip 7A at 44° C., the temperature control means 5B maintains the temperature of the optical waveguide circuit chip 7B at 53° C., and also the temperature control means 5C maintains the temperature of the optical waveguide circuit chip 7C at 55° C. Then, in the second embodiment, the optical transmission center wavelengths of the corresponding optical multiplexing/demultiplexing circuits 8(8A, 8B, 8C) could be made substantially coincident with the predetermined wavelengths by way of the temperature control.

While the optical wavelength multiplexer/demultiplexer of the second embodiment has been arranged with employment of the above-explained structure, a transmission/wavelength characteristic of this optical wavelength multiplexer/demultiplexer of this second embodiment could be obtained as indicated in FIG. 6. As apparent from FIG. 6, as to the optical wavelength multiplexer/demultiplexer of the second embodiment, such an optical wavelength multiplexer/demultiplexer having the transmission/wavelength characteristic could be realized, in which the insertion loss in the optical transmission center wavelength was approximately 3 dB, and the isolation was approximately 32 dB. Similarly, the second embodiment could achieve a similar effect to that of the above-explained first embodiment.

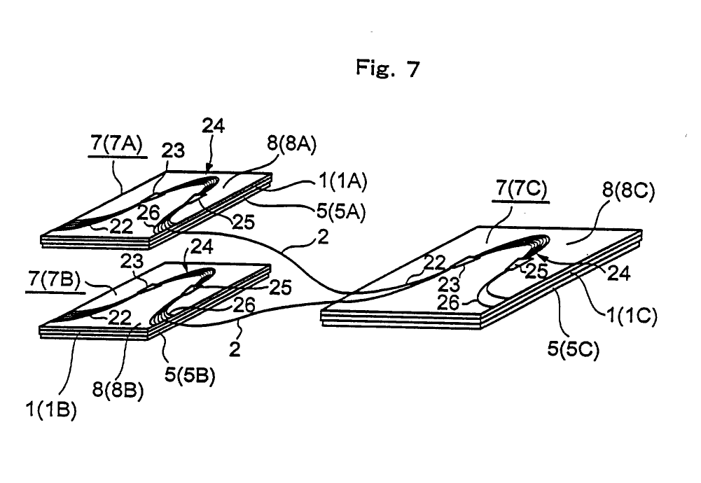

FIG. 7 is an essential-part structural view of an optical wavelength multiplexer/demultiplexer according to a third embodiment of the present invention as a perspective view.

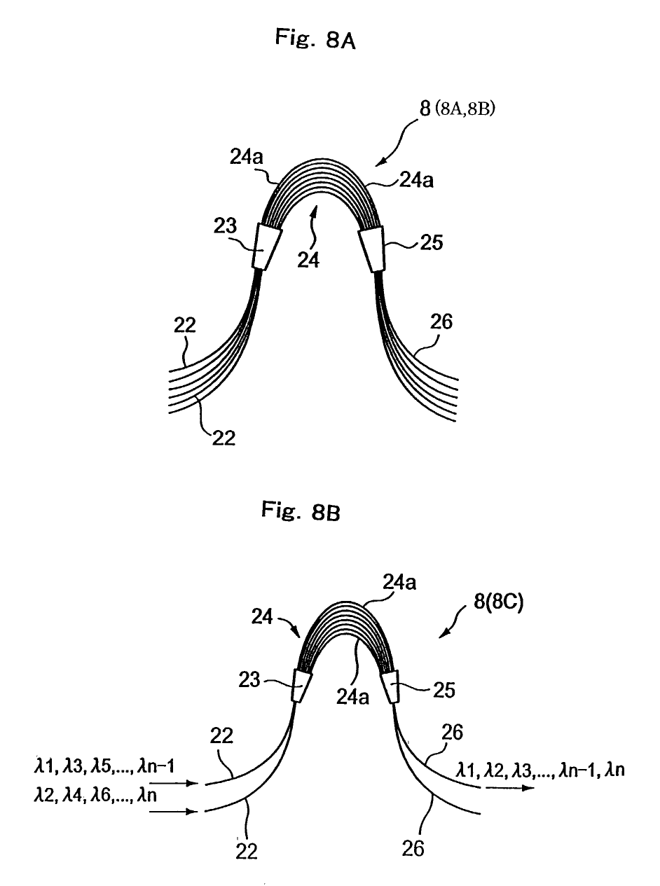

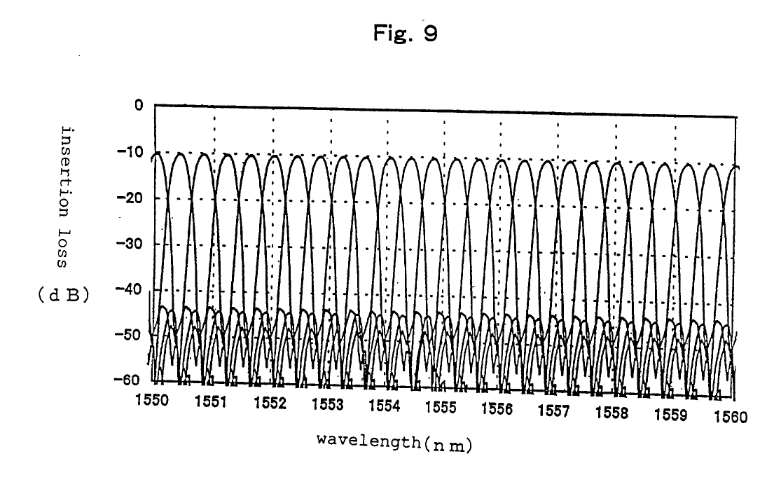

The optical wavelength multiplexer/demultiplexer of the third embodiment is arranged in such a manner that a plurality of optical waveguide circuit chips 7(7A, 7B, 7C) are connected to each other. In this case, three pieces of optical waveguide circuit chips 7 are employed. The optical waveguide circuit chips 7(7A, 7B, 7C) are manufactured by that both optical multiplexing/demultiplexing circuits 8(8A, and 8B) of an arrayed waveguide grating respectively as shown in FIG. 8A, and an optical multiplexing/demultiplexing circuit 8(8C) of an arrayed waveguide grating as indicated in FIG. 8B are formed on substrates 1(1A, 1B, 1C) which are different from each other.

As described above, the optical wavelength multiplexer/demultiplexer of the third embodiment is manufactured in such a way that the structures of the optical multiplexing/demultiplexing circuits 8(8A, 8B, 8C) formed on the substrates 1(1A, 1B, 1C) are made different from the structures of the above-described first embodiment. Also, in the optical wavelength multiplexer/demultiplexer of the third embodiment, the optical waveguide circuit chip 7(7C) is connected to output ends of the optical waveguide chips 7(7A, 7B). Since structures of the third embodiment other than the above-described structures are similar to those of the first embodiment, explanations thereof are omitted, or will be simply made.

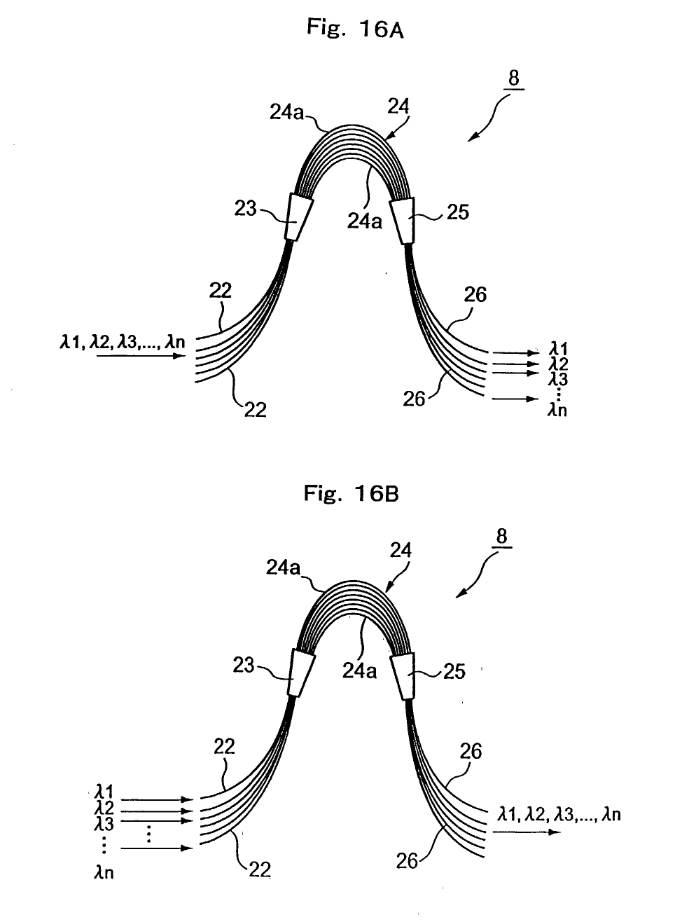

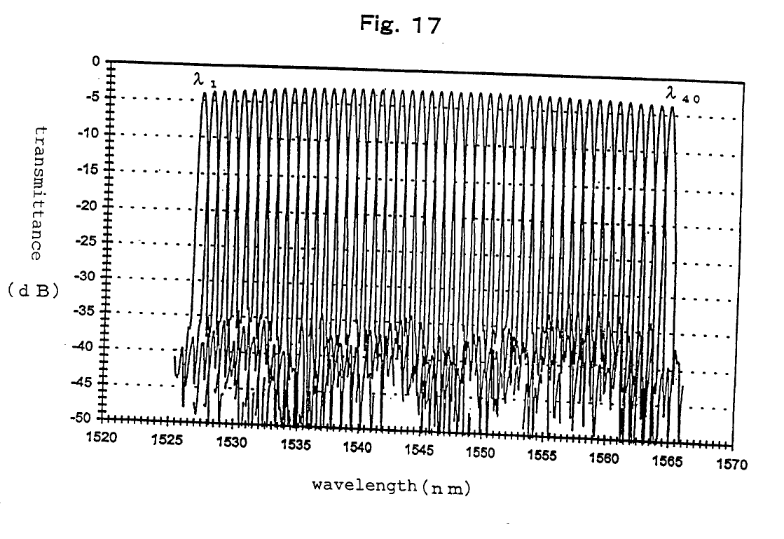

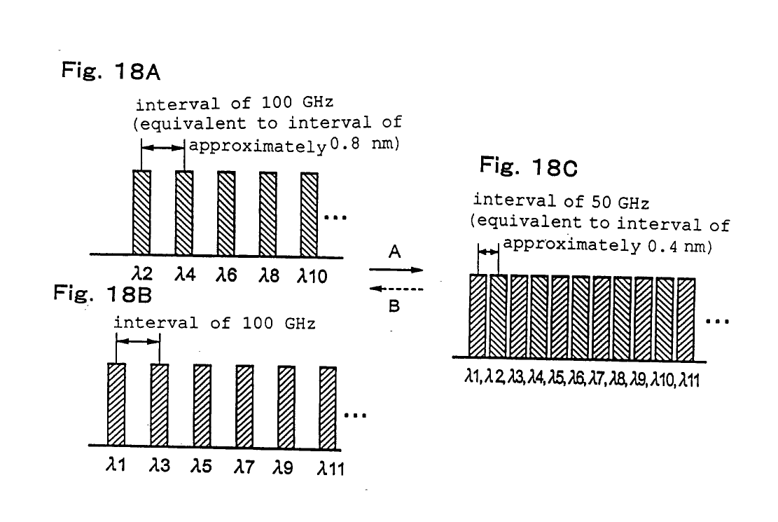

In the optical wavelength multiplexer/demultiplexer of this third embodiment, the optical multiplexing/demultiplexing circuits 8(8A, 8B) own such a circuit arrangement as shown in FIG. 8A. This circuit arrangement and a function thereof are similar to the circuit arrangement and the function of the arrayed waveguide grating indicated in FIG. 16A and FIG. 16B. While the optical multiplexing/demultiplexing circuits 8(8A, 8B) own such a function capable of multiplexing/demultiplexing light having 40 channels of wavelengths in a channel interval of 100 GHz, the optical multiplexing/demultiplexing circuits 8(8A, 8B) execute such operations as shown in FIG. 16B. A relative refractive index difference between a core and a cladding provided around this core, which constitute an optical waveguide, is equal to 0.80%.

The optical multiplexing/demultiplexing circuit 8(8C) owns such a circuit structure as shown in FIG. 8B, and may function as an interleaver type optical wavelength multiplexer/demultiplexer.

The optical multiplexing/demultiplexing circuit 8(8C) may function as the interleaver type optical wavelength multiplexer/demultiplexer which multiplexes, for example, wavelength-multiplexed incident light having an interval of 100 GHz with such a wavelength-multiplexed light having an interval of 50 GHz.

The optical multiplexing/demultiplexing circuit 8(8C) contains the circuit arrangement shown in FIG. 8B. The optical multiplexing/demultiplexing circuit 8(8C), for instance, as indicated by an arrow of FIG. 8B, multiplexes wavelength-multiplexed light having wavelengths of λ₁, λ₃, λ₅, - - - , λₙ₋₁ with wavelength-multiplexed light having wavelengths of λ₂, λ₄, λ₆, - - - , λₙ, in which an interval of adjacent wavelengths is 100 GHz, to output the resulting wavelength-multiplexed light. This output light may constitute such wavelength-multiplexed light having such wavelengths λ₁, λ₂, λ₃, - - - , λₙ₋₁, and λₙ whose intervals are 50 GHz as to adjacent wavelengths.

Contrary to the operations of FIG. 8B, the optical multiplexing/demultiplexing circuit 8(8C) also owns such a wavelength dividing (demultiplexing) function that, for example, the wavelength-multiplexed light having the wavelengths of λ₁, λ₂, λ₃, - - - , λₙ, λₙ₋₁, is demultiplexed so as to obtain both wavelength-multiplexed light having wavelengths of λ₁, λ₃, λ₅, - - - , λₙ₋₁, and also wavelength-multiplexed light having wavelengths of λ₂, λ₄, λ₆, - - - , λₙ.

In this third embodiment, the optical waveguide circuit chips 7(7A, 7B, 7C) are manufactured in a similar manner to that of the above-described first embodiment except that core patterns of the optical multiplexing/demultiplexing circuit 8(8A, 8B, 8C) are made different from the core patterns of the first embodiment. The Inventors of the present invention measured optical transmission center wavelengths of the optical multiplexing/demultiplexing circuits 8(8A, 8B, 8C) at a predetermined temperature (for example, 25° C.) with respect to each of the optical waveguide circuit chips 7(7A, 7B, 7C).

As a result of this measurement, the following fact can be revealed. That is, with respect to the predetermined wavelength of 1550.9 nm used as a grid, the optical transmission center wavelength of the optical multiplexing/demultiplexing circuit 8A was shifted to a short wavelength side by 0.43 nm. Also, the optical transmission center wavelength of the optical multiplexing/demultiplexing circuit 8B was shifted to a short wavelength side by 0.3 nm with respect to the above-described predetermined wavelength of 1550.9 nm, and further, the optical transmission center wavelength of the optical multiplexing/demultiplexing circuit 8C was shifted to a short wavelength side by 0.35 nm.

Since the temperature depending characteristic of the optical transmission center wavelength of the silica-based waveguide corresponds to 0.01 nm/° C., in order that the optical transmission center wavelengths of the respective optical multiplexing/demultiplexing circuits 8(8A, 8B, 8C) are made coincident with the predetermined wavelengths, the temperature of the optical multiplexing/demultiplexing circuit 8A may be set to 68° C. Also, the temperature of the optical multiplexing/demultiplexing circuit 8B may be set to 55° C. Also, the temperature of the optical multiplexing/demultiplexing circuit 8C may be set to 60° C.

As a consequence, as indicated in FIG. 7, in the third embodiment, the optical transmission center wavelengths of the corresponding optical multiplexing/demultiplexing circuits 8(8A, 8B, 8C) could be made substantially coincident with the predetermined wavelengths in such a manner that while the optical waveguide circuit chips 7(7A, 7B, 7C) are connected via the optical fiber 2 to each other, the temperature control by the temperature control means 5(5A, 5B, 5C) are carried out.

In other words, the temperature control means 5A maintains the temperature of the optical waveguide circuit chip 7A at 68° C. Also, the temperature control means 5B maintains the temperature of the optical waveguide circuit chip 7B at 55° C. Also, the temperature control means 5C maintains the temperature of the optical waveguide circuit chip 7C at 60° C. Since these temperature control operations are carried out, the optical transmission center wavelengths of the corresponding optical multiplexing/demultiplexing circuits 8(8A, 8B, 8C) could be made substantially identical to the predetermined wavelengths in the third embodiment.

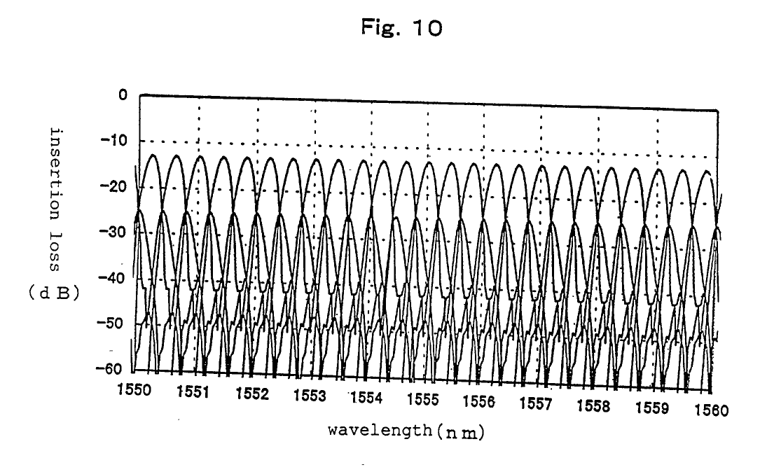

While the optical wavelength multiplexer/demultiplexer of the third embodiment has been arranged with employment of the above-explained structure, a transmission/wavelength characteristic of this optical wavelength multiplexer/demultiplexer of this third embodiment could be obtained as indicated in FIG. 9.

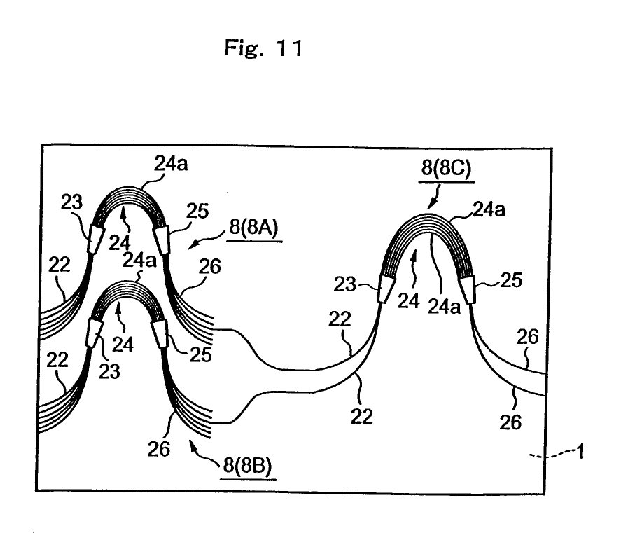

It should be understood that FIG. 11 represents an optical wavelength multiplexer/demultiplexer of a comparison example 1, in which both the optical multiplexing/demultiplexing circuits 8(8A and 8B) shown in FIG. 8A, and also the optical multiplexing/demultiplexing circuit 8(8C) indicated in FIG. 8B are formed on the same substrate. In the case that these optical multiplexing/demultiplexing circuits 8(8A, 8B, 8C) are formed on the same substrate, as represented in FIG. 11, the temperature adjustments of the respective optical multiplexing/demultiplexing circuits cannot be separately carried out. Therefore, a transmission/wavelength characteristic of the optical wavelength multiplexer/demultiplexer of this comparison example 1 was obtained as shown in FIG. 10.

As apparent from the comparison result between FIG. 9 and FIG. 10, the following fact can be revealed. That is, in comparison with the above-described comparison example 1, the optical wavelength multiplexer/demultiplexer of the third embodiment can have such an optical transmission characteristic that the isolation becomes high, and the insertion loss in the optical transmission center wavelength is low, and further, the adjacent crosstalk is low.

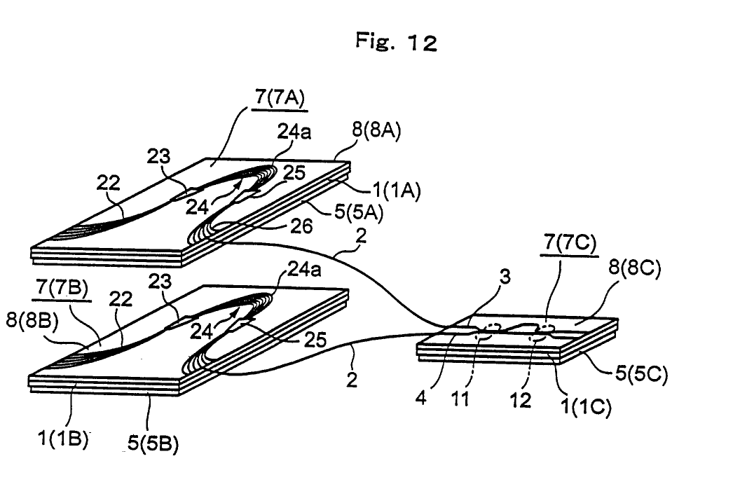

FIG. 12 is an essential-part structural view of an optical wavelength multiplexer/demultiplexer according to a fourth embodiment of the present invention, as a perspective view.

While the optical wavelength multiplexer/demultiplexer of the fourth embodiment is arranged in a substantially similar to that of the third embodiment, descriptions of such similar constructures of this fourth embodiment with respect to those of the third embodiment are omitted, or will be simply made. A different structure of this fourth embodiment from that of the third embodiment is given as follows: That is, an optical multiplexing/demultiplexing circuit 8(8C) is arranged as an optical multiplexing/demultiplexing circuit of such a Mach-Zehnder optical interferometer as illustrated in FIG. 19, and also, a temperature control means 5 is constituted by employing a Peltier device.

In the fourth embodiment, the optical multiplexing/demultiplexing circuit 8(8C) may function as the interleaver type optical wavelength multiplexer/demultiplexer which multiplexes, for example, such wavelength-multiplexed light having an interval of 100 GHz as incident light with such a wavelength-multiplexed light having an interval of 50 GHz.

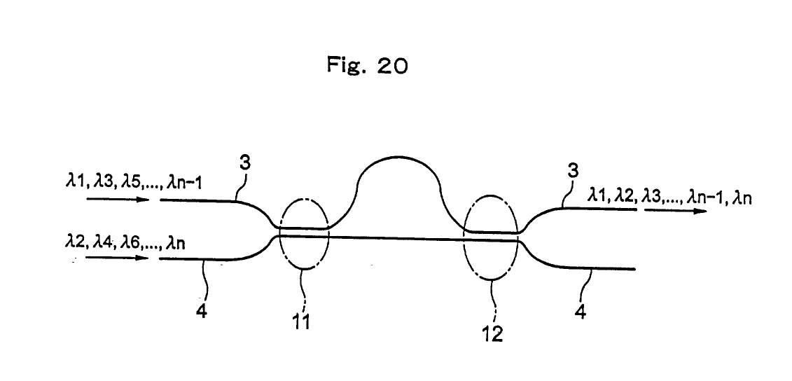

In other words, this optical multiplexing/demultiplexing circuit 8(8C), for instance, as indicated by an arrow of FIG. 20, multiplexes wavelength-multiplexed light having wavelengths of λ₁, λ₃, λ₅, - - - , λₙ₋₁ whose intervals as to adjacent wavelengths are 100 GHz with wavelength-multiplexed light having wavelengths of λ₂, λ₄, λ₆, - - - , λₙ to output the resulting wavelength-multiplexed light. The intervals as to the adjacent wavelengths of the above-described wavelength-multiplexed light having the wavelengths of λ₂, λ₄, λ₆, - - - , λₙ are similarly 100 GHz. This output light may constitute such wavelength-multiplexed light having such wavelengths λ₁, λ₂, ₃, - - - , λₙ₋₁, and λₙ, whose intervals are 50 GHz as to adjacent wavelengths thereof.

Contrary to the operations of FIG. 20, the optical multiplexing/demultiplexing circuit 8(8C) also owns such a wavelength dividing function. That is, this wavelength dividing function corresponds to such a function that, for example, such wavelength-multiplexed light having wavelengths of λ₁, λ₂, λ₃, - - - , λₙ₋₁, and λₙ, is demultiplexed, whose intervals are 50 GHz as to adjacent wavelengths. Since this demultiplexing operation is carried out, both wavelength-multiplexed light having wavelengths of λ₁, λ₃, λ₅, - - - , λₙ₋₁, whose intervals are 100 GHz as to adjacent wavelengths, and also, wavelength-multiplexed light having wavelengths of λ₂, λ₄, λ₆, - - - , λₙ, whose intervals are similarly 100 GHz as to adjacent wavelengths may be formed.

In this fourth embodiment, the optical waveguide circuit chips 7(7A, 7B, 7C) are manufactured in a similar manner to that of the above-described third embodiment except that a pattern for forming an optical waveguide core of the optical multiplexing/demultiplexing circuit 8(8C) is made by a circuit pattern of a Mach-Zehnder optical interferometer. Thereafter, the Inventors of the present invention measured optical transmission center wavelengths of the optical multiplexing/demultiplexing circuits 8(8A, 8B, 8C) at a predetermined temperature (for example, 25° C.) with respect to each of the optical waveguide circuit chips 7(7A, 7B, 7C).

As a result of this measurement, the following fact can be revealed in this fourth embodiment. That is, with respect to the predetermined wavelength of 1550.9 nm used as a grid, the optical transmission center wavelength of the optical multiplexing/demultiplexing circuit 8A was shifted to a short wavelength side by 0.15 nm. Also, the optical transmission center wavelength of the optical multiplexing/demultiplexing circuit 8B was shifted to a short wavelength side by 0.22 nm. Also, the optical transmission center wavelength of the optical multiplexing/demultiplexing circuit 8C was shifted to a short wavelength side by 0.23 nm.

As previously explained, since the temperature depending characteristic of the optical transmission center wavelength of the silica-based waveguide is 0.01 nm/° C., in order that the optical transmission center wavelengths of the respective optical multiplexing/demultiplexing circuits 8(8A, 8B, 8C) are made coincident with the predetermined wavelengths, the temperature of the optical multiplexing/demultiplexing circuit 8A may be set to 40° C. Also, the temperature of the optical multiplexing/demultiplexing circuit 8B may be set to 47° C. Also, the temperature of the optical multiplexing/demultiplexing circuit 8C may be set to 48° C.

As a consequence, as indicated in FIG. 12, in the fourth embodiment, the optical transmission center wavelengths of the corresponding optical multiplexing/demultiplexing circuits 8(8A, 8B, 8C) could be made substantially coincident with the predetermined wavelengths in such a manner that while the optical waveguide circuit chips 7(7A, 7B, 7C) are connected via the optical fiber 2 to each other, the temperature controls by the temperature control means 5(5A, 5B, 5C) are carried out.

The temperature control means 5A maintains the temperature of the optical waveguide circuit chip 7A at 40° C. Also, the temperature control means 5B maintains the temperature of the optical waveguide circuit chip 7B at 47° C. Also, the temperature control means 5C maintains the temperature of the optical waveguide circuit chip 7C at 48° C. Since these temperature control operations are carried out, the optical transmission center wavelengths of the corresponding optical multiplexing/demultiplexing circuits 8(8A, 8B, 8C) could be made substantially identical to the predetermined wavelengths in the fourth embodiment.

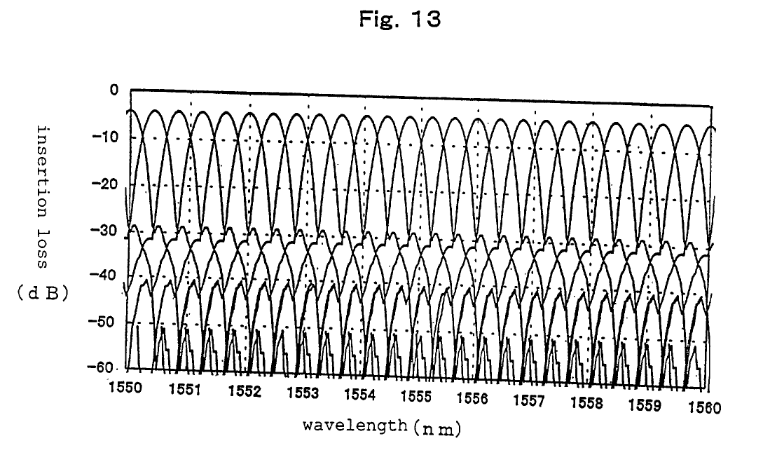

While the optical wavelength multiplexer/demultiplexer of the fourth embodiment has been arranged with employment of the above-explained structure, a transmission/wavelength characteristic of this optical wavelength multiplexer/demultiplexer of this fourth embodiment could be obtained as indicated in FIG. 13.

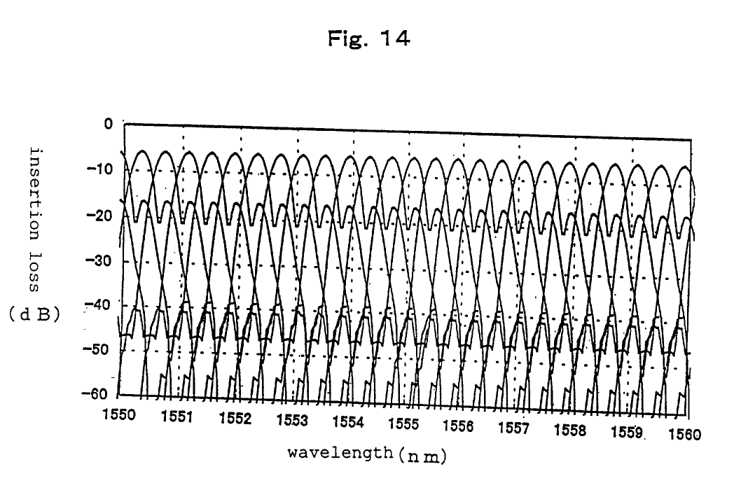

Also, as shown in FIG. 15, in an optical wavelength multiplexer/demultiplexer of a comparison example 2 in which the optical multiplexing/demultiplexing circuits 8(8A, 8B, 8C) applied to the fourth embodiment are formed on the same substrate, the temperature adjustments of the respective optical multiplexing/demultiplexing circuits 8(8A, 8B, 8C) cannot be separately carried out. Therefore, a transmission/wavelength characteristic of the optical wavelength multiplexer/demultiplexer of this comparison example 2 was obtained as shown in FIG. 14.

As apparent from the comparison result between FIG. 13 and FIG. 14, the following fact can be revealed. That is, in comparison with the above-described comparison example 2, the optical wavelength multiplexer/demultiplexer of the fourth embodiment can have such a optical transmission characteristic that the isolation becomes high, and the insertion loss in the optical transmission center wavelength is low, and further, the adjacent crosstalk is low.

It should also be noted that the present invention is not limited to the above-explained various embodiments, but may be realized by employing other various embodiments. For example, in the respective embodiments, three sets of optical waveguide circuit chips 7(7A, 7B, 7C) are connected in two stages so as to construct the optical wavelength multiplexer/demultiplexer. However, there is no limitation as to a total number and also a total stage of these optical waveguide circuit chips 7 which constitute the optical wavelength multiplexer/demultiplexer of the present invention.

Also, as indicated in the above-described first, second, and fourth embodiments, in the case that the optical wavelength multiplexer/demultiplexer is formed by employing the optical multiplexing/demultiplexing circuit 8 of the Mach-Zehnder optical interferometer, each of these optical multiplexing/demultiplexing circuits 8 may be constituted as a circuit of a Mach-Zehnder optical interferometer containing four sets, or more sets of directional coupling portions.

Furthermore, in accordance with the present invention, the dimension of the core which constitutes the optical multiplexing/demultiplexing circuit 8 is not limited to a specific dimension, but may be properly set. For example, in the case that circuits of Mach-Zehnder optical interferometers are formed, since each of the circuits is constituted by a single mode waveguide by considering used wavelengths and relative refractive index differences, similar effects to those of the first, second, and fourth embodiments may be achieved.

Furthermore, in accordance with the present invention, in such a case that the optical multiplexing/demultiplexing circuit 8 is arranged as a structure having a circuit of an arrayed waveguide grating, a detailed circuit arrangement of this arrayed waveguide grating is not specifically limited, but may be properly set.

In addition, the optical multiplexing/demultiplexing circuit 8 may be arranged not only by either a circuit of an arrayed waveguide grating, or a circuit of a Mach-Zehnder optical interferometer, but also by such a circuit having a wavelength multiplexing/demultiplexing function formed by an optical waveguide. It should also be noted that when the optical multiplexing/demultiplexing circuit 8 is arranged by such a circuit of an arrayed waveguide grating, or a circuit of a Mach-Zehnder optical interferometer, such an optical wavelength multiplexer/demultiplexer capable of multiplexing/demultiplexing such light having a plurality of wavelengths in a narrow wavelength interval may be correctly constituted.

Furthermore, in the above-explained embodiment modes, the temperature control means 5 is constructed of the heater, or the Peltier device. However, the structure of this temperature control means 5 is not limited to the above-described construction, but may be properly set.

What is claimed is:

1. An optical wavelength multiplexer/demultiplexer comprising:
a plurality of optical waveguide circuit chips formed on different respective substrates, each of said plurality of optical waveguide circuit chips including
an optical multiplexing/demultiplexing circuit having optical waveguides configured to perform a wavelength multiplexing/demultiplexing operation on optical signals of differing wavelengths, wherein
said plurality of optical waveguide circuit chips are connected in a multiple stage configuration.

2. An optical wavelength multiplexer/demultiplexer according to claim 1, wherein:
said plurality of optical waveguide circuit chips are connected to each other with at least one optical fiber.

3. An optical wavelength multiplexer/demultiplexer according to claim 2, wherein:
said at least one optical fiber is coupled to said plurality of optical waveguide circuit chips with an ultraviolet hardening agent.

4. An optical wavelength multiplexer/demultiplexer according to claim 1, further comprising:
means for controlling temperature in each of said plurality of optical waveguide circuits and adjusting an optical transmission center wavelength of the optical multiplexing/demultiplexing circuit that corresponds with a corresponding one of the plurality of optical waveguide circuits.

5. An optical wavelength multiplexer/demultiplexer according to claim 4, wherein:
said means for controlling temperature comprises a heater or Peltier device.

6. An optical wavelength multiplexer/demultiplexer according to claim 1, wherein:
said multiple stage configuration is arranged as an interleaver optical wavelength multiplexer/demultiplexer.

7. An optical wavelength multiplexer/demultiplexer according to claim 4, wherein:
said means for controlling temperature includes means for adjusting the optical transmission center wavelength of the corresponding one of the optical multiplexing/demultiplexing circuits to be substantially coincident with a predetermined wavelength.

8. An optical wavelength multiplexer/demultiplexer according to claim 1, wherein:
said optical multiplexing/demultiplexing circuit comprises a Mach-Zehnder optical interferometer circuit.

9. An optical wavelength multiplexer/demultiplexer according to claim 8, wherein:
said Mach-Zehnder optical interferometer circuit includes
a first optical waveguide,
a second optical waveguide arranged side-by-side with respect to said first optical waveguide, and
a plurality of directional coupling portions respectively formed where a portion of said first optical waveguide is located adjacent to and in proximity to a portion of said second optical waveguide for a predetermined interval along a longitudinal direction of both said first and second optical waveguides, and
respective segments of the first optical waveguide and the second optical waveguide that are sandwiched between adjacent directional coupling portions having different lengths from one another.

10. An optical wavelength multiplexer/demultiplexer according to claim 1, wherein:
the optical multiplexing/demultiplexing circuit includes an arrayed waveguide grating.

11. The optical wavelength multiplexer/demultiplexer according to claim 1, wherein:
the arrayed waveguide grating includes
at least one optical input waveguide having an output end,
a first slab waveguide connected to the output end of said at least one optical input waveguide,
an arrayed waveguide connected to an output end of said first slab waveguide, and constituted by a plurality of channel waveguides arranged side-by-side, whose setting amounts, ΔL, and lengths are different from each other,
a second slab waveguide connected to an output end of said arrayed waveguide, and
a plurality of optical output waveguides arranged side by side and connected to an output end of said second slab waveguide.

12. An optical wavelength multiplexer/demultiplexer according to claim 1, wherein:
said plurality of optical waveguide circuit chips are connected by abutment of respective edge surfaces of the optical waveguide circuit chips.

13. An optical wavelength multiplexer/demultiplexer according to claim 12, further comprising:
means for controlling temperature in each of said plurality of optical waveguide circuits and adjusting an optical transmission center wavelength of the optical multiplexing/demultiplexing circuit that corresponds with a corresponding one of the plurality of optical waveguide circuits.

14. An optical wavelength multiplexer/demultiplexer according to claim 13, wherein:
said means for controlling temperature comprises a heater or Peltier device.

15. An optical wavelength multiplexer/demultiplexer comprising:
a plurality of optical waveguide circuit chips formed on different respective substrates, each of said plurality of optical waveguide circuit chips including
an optical multiplexing/demultiplexing circuit having optical waveguides configured to perform a wavelength multiplexing/demultiplexing operation on optical signals of differing wavelengths, wherein
said plurality of optical waveguide circuit chips are connected to each other so as to be coupled in a multiple stage configuration and arranged as an interleaver optical wavelength multiplexer/demultiplexer,
respective outputs of a first and a second of the optical multiplexing/demultiplexing circuits respectively contained on the plurality of optical waveguide circuit chips are connected to inputs of a third of the optical multiplexing/demultiplexing circuits,
the first and the second of the optical multiplexing/demultiplexing circuits being arrayed waveguide gratings, and
the third of the optical multiplexing/demultiplexing circuits being a Mach-Zehnder optical interferometer circuit.
